(19) United States
(12) Patent Application Publication
(10) Pub. No.: US 2010/0017215 A1
(43) Pub. Date: Jan. 21, 2010

(54) PUBLIC TRANSPORTATION STANDING AND SITTING ROOM NOTIFICATION SYSTEM

(76) Inventors: Meena Nigam, Belmont, CA (US); Lisa A. Seacat, San Francisco, CA (US)

Correspondence Address: Dillon & Yudell, LLP, 8911 N. Capital of Texas Hwy., Suite 2110, Austin, TX, 78759, US

(21) Appl. No.: 12/174,453

(22) Filed: Jul. 16, 2008

(51) Int. Cl. G06Q 10/00

(52) U.S. Cl. 705/1

(57) ABSTRACT

A method, system, and computer program product for transmitting, in real time, notification of the number of passengers riding on a public transportation vehicle. A passenger count is transmitted by an electronic counting system on a public transportation vehicle. The passenger count is received by a passenger notification device in real time. The passenger notification device then transmits a notification message containing the passenger count and a known capacity of the public transportation vehicle to a remote telecommunication device. The notification message transmitted by the passenger notification device may also contain supplemental information of additional features of the public transportation vehicle, and suggest alternative route options to the user. Additionally, the notification message may contain predictive information of the number of available spaces on the public transportation vehicle by referencing historical passenger data to further determine the likelihood that a person will be able to board.

### BACKGROUND OF THE INVENTION

1. Technical Field

The present invention relates to transmitting notification of passenger levels in public transportation vehicles.

2. Description of the Related Art

Public transportation often times results in overcrowded public transportation vehicles, such as buses or trains, during peak travel periods. Current systems may provide scheduled arrival times of incoming buses. However, currently there no available system for autonomously notifying passengers when a bus is full and that they should therefore adjust their travel plans. This leaves many travelers standing on a curb waiting to board a bus while other full busses pass them by. Additionally, currently there is no way to better provide an estimate of approximate arrival times at a specific destination given space analysis directly to a user.

### SUMMARY OF THE INVENTION

A method, system, and computer program product for transmitting, in real time, notification of the number of passengers riding on a public transportation vehicle. A passenger count is transmitted by an electronic counting system on a public transportation vehicle. The passenger count is received by a passenger notification device in real time. The passenger notification device then transmits a notification message containing the passenger count and a known capacity of the public transportation vehicle to a remote telecommunication device. The notification message transmitted by the passenger notification device may also contain supplemental information of additional features of the public transportation vehicle, and suggest alternative route options to the user. Additionally, the notification message may contain predictive information of the number of available spaces on the public transportation vehicle by referencing historical passenger data to further determine the likelihood that a person will be able to board.

The above as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, however, will best be understood by reference to the following detailed descriptions of an illustrative embodiment when read in conjunction with the accompanying drawings, wherein:

FIG. 1 is a block diagram of a passenger notification device in which the present invention may be implemented.

FIG. 2 is a block diagram of an exemplary system for sending a remote telecommunication device notification about current passenger counts on a public transportation vehicle.

FIG. 3 is a high-level logical flowchart of an exemplary method for sending a remote telecommunication device notification about current passenger counts of a public transportation vehicle.

### DETAILED DESCRIPTION OF THE PREFERRED EMBODIMENT

The illustrative embodiments provide a method, system, and computer program for transmitting real-time notification of the number of available spaces of a public transportation vehicle, in accordance with one embodiment of the invention.

In the following detailed description of exemplary embodiments of the invention, specific exemplary embodiments in which the invention may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present invention. The following detailed description is, therefore, not to be taken in a limiting sense, and the scope of the present invention is defined only by the appended claims.

It is understood that the use of specific component, device and/or parameter names are for example only and not meant to imply any limitations on the invention. The invention may thus be implemented with different nomenclature/terminology utilized to describe the components/devices/parameters herein, without limitation. Each term utilized herein is to be given its broadest interpretation given the context in which that term is utilized.

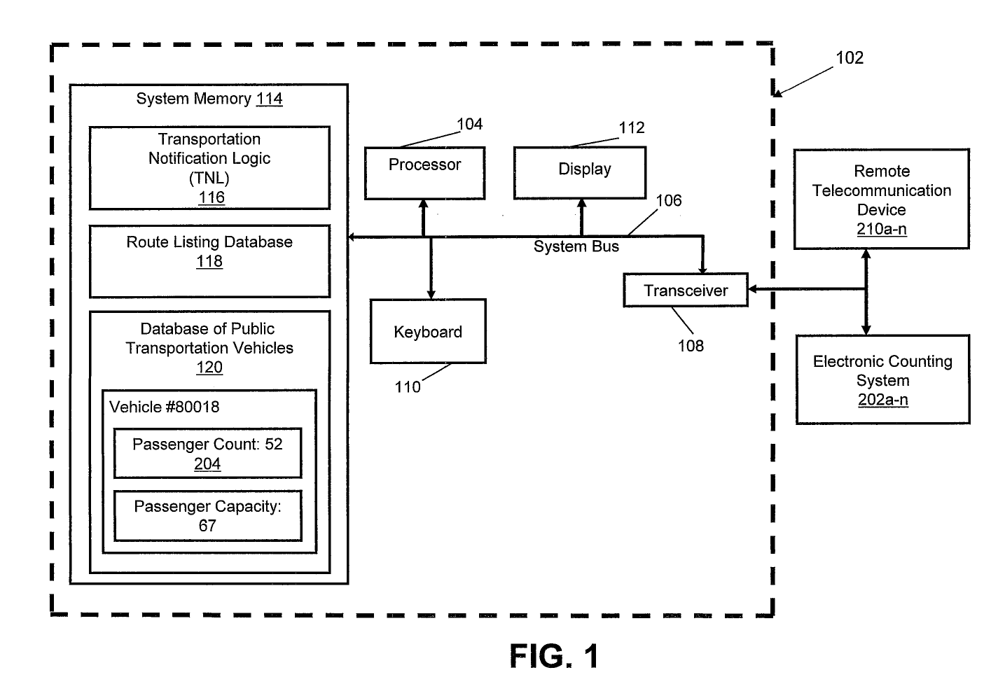

With reference now to FIG. 1, there is depicted a block diagram of an exemplary passenger notification device (PND) 102 in which the present invention may be implemented. PND 102 includes a processor 104 that is coupled to a system bus 106. A transceiver 108, which uses a wired or wireless technology to connect to electronic counting systems 208. Additionally, transceiver 108 may be used to connect to remote telecommunication devices 210, is also coupled to system bus 106. A keyboard 110, connected to system bus 106, permits data entry by a user of PND 102. Display 112, coupled to system bus 106, allows for presentation of text and graphics, including route information and a general user interface for use by a person using PND 102.

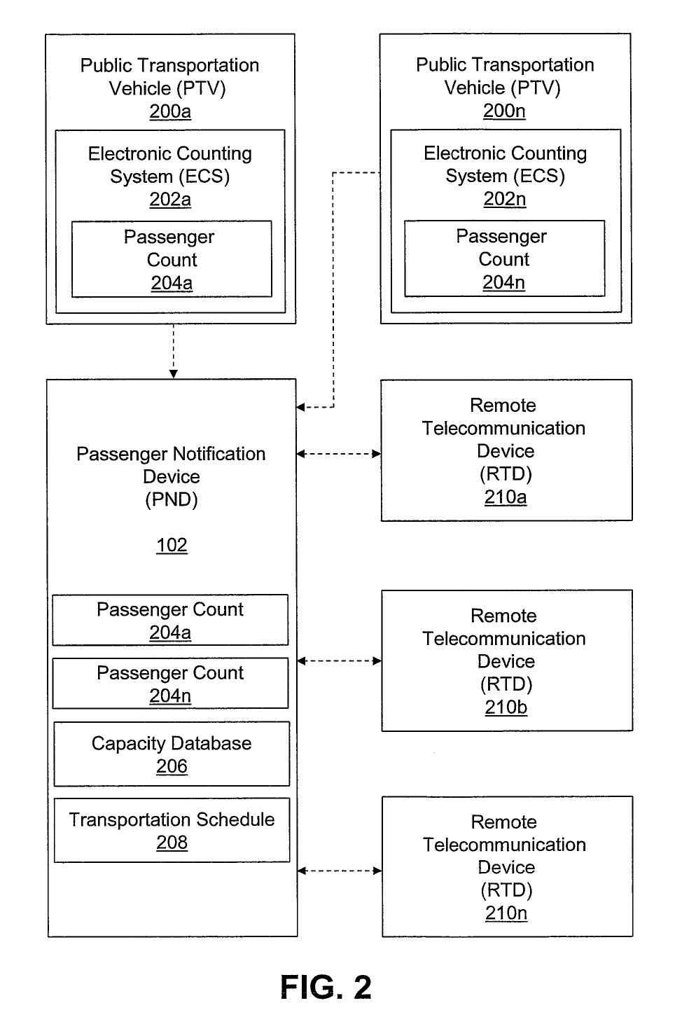

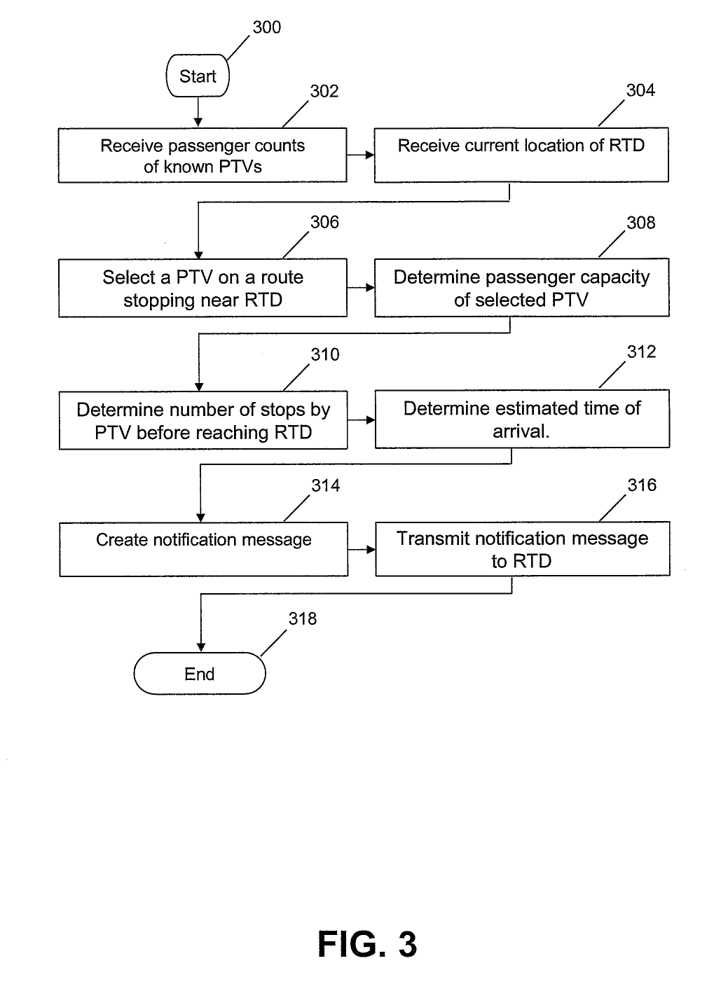

System memory 114 is connected to system bus 106. System memory 114 of PND 102 includes transportation notification logic (TNL) 116. TNL 116 includes code for implementing the processes described in FIG. 2-3. In one embodiment, PND 102 is able to utilize TNL 118 to determine if there is room for additional passengers on a public transportation vehicle and notify configured remote telecommunication devices 210 of space available on a public transportation vehicle, as described in greater detail below in FIG. 2-3.

System memory 114 also comprises route listing database 118, which contains a listing of all routes of public transportation vehicles programmed within PND 102.

As shown, system memory 114 also comprises database of the public transportation vehicle 120, which includes listings of current passenger counts 204 and passenger capacity of the public transportation vehicle. In one embodiment, PND 102 contains info of multiple public transportation vehicles. PND 102 uses Database of Public Transportation Vehicles 120 to maintain profiles of public transportation vehicles 200 monitored by PND 102. A database listing of a public transportation vehicle may be autonomously updated by data received by transceiver 108 of PTV 200. Additionally, a listing for each public transportation vehicle may contain supplemental information of any equipment or special features of the public transportation vehicle (e.g., whether the public transportation vehicle can accommodate handicapped persons, or has installed bicycle racks). A profile (not shown) contained within the database of public transportation vehicles 120 may also maintain historical information regarding past Passenger Counts 204 for a particular time of day, day of week, etc.

The hardware elements depicted in PND 102 are not intended to be exhaustive, but rather are representative to highlight components required by and/or utilized to implement the present invention.

Note also that in an alternate embodiment, the architecture shown in FIG. 1 for PND 102 may be incorporated in Electronic Counting Systems (ECS) 202 shown below in FIG. 2.

With reference now to FIG. 2, a block diagram of an exemplary system for sending a Remote Telecommunication Device notification about current passenger counts on a public transportation vehicle. ECS 202a-n, where n is an integer, continuously measures Passenger Count 204a-n, which is the current number of passengers on the Public Transportation Vehicle (PTV) 200a-n. ECS 202a-n is an electronic counting system on each PTV 200a-n which serves to maintain a real time count of the number of passengers on a PTV 200a-n. ECS 202a-n uses an electronic method for counting passengers of PTV 200a-n (e.g., Radio Frequency Identification (RFID), manual counting systems, personal area network (PAN), scanners). For each passenger boarding PTV 200a-n, the count is incremented. Similarly, the count is decremented for each passenger leaving PTV 200a-n. ECS 202a-n may autonomously transmit the Passenger Count 204a-n of a PTV 200a-n to PND 102 at specific time intervals, or when Passenger Count 204a-n changes. PTV 200a-n may be any public transportation vehicle that carries passengers over a distance (e.g., bus, train, boat, ferry, airplane, etc).

A Passenger Count 204a-n is maintained for each PTV 200a-n and is periodically transmitted to a PND 102 by an ECS 202a-n of PTV 200a-n. PND 102 may then transmit this information to a configured Remote Telecommunication Device (RTD) 210a-n as one component of a notification message to notify a user of an RTD 210a-n of how many passengers are currently riding on a select PTV 200a-n.

A notification message transmitted by PND 102 may contain a Passenger Count 204a-n and a known passenger capacity of a PTV 200a-n, of one or more PTVs 200a-n, determined to be passing within the closest proximity of the current location of RTD 210a-n. The notification message may also contain additional information regarding the estimated time of arrival of a PTV 200 at a route stop, suggested alternate routes or PTVs 200a-n. The message may further contain the aforementioned supplemental information of any equipment or special features of the PTVs 200a-n. PND 102 may be additionally configured to transmit a count available standing room spaces, and a count of the number of seats available on a PTV 200a-n, to help assist individuals unable to stand for long durations. The notification message may also contain the number of available handicapped accessible seats of a PTV 200a-n. The notification message PND 102 may also utilize logic (e.g., TNL 116) to reference the real-time and historical passenger data saved in Database of Public Transportation Vehicles 120 (FIG. 1) against Route Listing Database 118. Historical passenger data may additionally contain information about an average number of passengers, time of day, type of transportation, and passenger capacity of a PTV 200a-n. The historical passenger data may be used by PND 102 to determine an estimated number of available spaces and estimated number of people riding on a PTV 200a-n at a given time. This information, when transmitted to a RTD 210a-n, may be used by a person utilizing RTD 210a-n to assist the user of RTD 210a-n in deciding if they desire to wait for the next PTV 200a-n, or a future PTV 200a-n to arrive, or make other arrangements. Historical passenger data collected by PND 102 may also be used to help public officials determine the proper number of routes to a stop and if additional routes are needed.

A notification message may additionally contain information about alternate PTVs 200a-n that may be stopping at or near the location of RTD 210a-n. The alternate routes may be determined by logic of PND 102 (e.g., TNL 116, FIG. 1) referencing the current location of RTD 210a-n with other PTVs 200a-n with routes passing in close proximity. The notification message may be transmitted as a text based message (e.g., email, instant message, short message service (SMS) message), or alternatively, the notification message may also be a voice recording. In an alternate embodiment, RTD 210a-n may also initiate a request with PND 102 to receive a notification message about only a specific PTV 200a-n specified by the RTD 210a-n.

The location of RTD 210a-n may be transmitted with an initial notification request by RTD 210a-n to receive information of a PTV 210a-n. The location of RTD 210a-n may alternatively be previously known by PND 102 or determined through the use of electronic locating (e.g., global positioning system (GPS), cellular phone triangulation).

RTD 210a-n may be any telecommunication device (e.g., mobile phone, PDA, computer terminal) with a connection to PND 102. RTDs 210a-n may receive notification messages of a PTV 200a-n by initiating a request with PND 102. RTDs 210a-n may be configured to autonomously accept information received in a notification message (e.g., displaying passenger counts of an arriving bus on an electronic display terminal at a bus stop). Additionally, RTD 210a-n may subscribe to a service of PND 102 requesting PND 102 to autonomously transmit an alarm to a RTD 210a-n when a route normally used by a user of an RTD 210a-n is overcrowded.

With reference now to FIG. 3, is a high-level logical flowchart of an exemplary method for sending notification to a remote telecommunication device regarding current passenger counts of a public transportation vehicle. After initiator block 300, a PND receives the current passenger count of the PTVs (block 302). It is important to note while this step is shown as the first step, the passenger count of a PTV is continuously updated by information received of PTVs. RTDs registered with PND transmit the current location of an RTD (block 304). PND then selects a PTV that is on a route that will be stopping at a location closest to the RTD (block 306). PND determines the passenger capacity of the selected PTV (block 308). PND also determines the number of stops the selected PTV will make before reaching the stop nearest RTD (block 310). Using this information and route data stored of PND, PND determines an estimated time of arrival to the stop nearest RTD (block 312). PND then creates a notification message intended for the querying RTD which contains relevant passenger information of the selected PTV (block 314). The notification is then transmitted to the RTD (block 316). The process then ends at terminator block 318.

Although aspects of the present invention have been described with respect to a computer processor and program application/logic, it should be understood that at least some aspects of the present invention may alternatively be implemented as a program product for use with a data storage system or computer system. Programs defining functions of the present invention can be delivered to a data storage system or computer system via a variety of signal-bearing media, which include, without limitation, non-writable storage media (e.g. CD-ROM), writable storage media (e.g. a floppy diskette, hard disk drive, read/write CD-ROM, optical media), and communication media, such as computer and telephone networks including Ethernet. It should be understood, therefore, that such signal-bearing media, when carrying or encoding computer readable instructions that direct method functions of the present invention, represent alternative embodiments of the present invention. Further, it is understood that the present invention may be implemented by a system having means in the form of hardware, software, or a combination of software and hardware as described herein or their equivalent.

Having thus described the invention of the present application in detail and by reference to illustrative embodiments thereof, it will be apparent that modifications and variations are possible without departing from the scope of the invention defined in the appended claims. In addition, many modifications may be made to adapt a particular system, device or component thereof to the teachings of the invention without departing from the essential scope thereof. Therefore, it is intended that the invention not be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another.

1. A method of transmitting in real time notification of the number of passengers riding on a public transportation vehicle to a remote telecommunication device, the method comprising:
receiving a current location of the remote telecommunication device;
selecting a public transportation vehicle from a plurality of public transportation vehicles, wherein the public transportation vehicle is on a route passing within the closest proximity of the current location of the remote telecommunication device;
receiving a passenger count of the public transportation vehicle, wherein the passenger count contains an amount of available standing room spaces of the public transportation vehicle, and a count of the number of available seats of the public transportation vehicle;
comparing the passenger count of the public transportation vehicle with a historical passenger data of the public transportation vehicle;
in response to comparing the passenger count of the public transportation vehicle with the historical passenger data of the public transportation vehicle, determining an estimated amount of spaces, wherein the estimated amount of spaces is the estimated amount of available seats and available standing room spaces of the public transportation vehicle when the public transportation vehicle reaches a destination; and
transmitting a notification message to the remote telecommunication device, wherein the notification includes one or more of:
the count of the number of available seats of the public transportation vehicle,
the amount of available standing room spaces of the public transportation vehicle,
the passenger capacity of the public transportation vehicle,
a list of supplemental features of the public transportation vehicle,
an amount of available handicapped accessible seats of the public transportation vehicle,
the estimated amount of spaces of the public transportation vehicle.

2-9. (canceled)
